(19) United States
(12) Patent Application Publication
(10) Pub. No.: US 2026/0035268 A1
(43) Pub. Date: Feb. 5, 2026

(54) WATER PURIFICATION DEVICE

(71) Applicant: Goodnature Products, Inc., Buffalo, NY (US)

(72) Inventor: Dale WETTLAUFER, Sarasota, FL (US)

(21) Appl. No.: 18/791,516

(22) Filed: Aug. 1, 2024

(51) Int. Cl. C02F 1/22; C02F 1/00

(52) U.S. Cl. CPC C02F 1/22; C02F 1/008; C02F 2209/02

(57) ABSTRACT

A cyclical water-purifying apparatus circulates impure raw water over a freezing surface to grow a purified ice mass by freezing a portion of the raw water as the raw water flows over the freezing surface, wherein an unfrozen portion of the flowing raw water transports impurities. The apparatus harvests the purified ice mass from the freezing surface and receives the purified ice mass in an ice receptacle. The purified ice mass may be melted by a heater associated with the ice receptacle within the apparatus housing, or delivered through an ice delivery opening in the housing to a container outside the housing for external melting. The ice mass may be formed as a single slab of substantially uniform thickness for more consistent melting time. The apparatus provides a compact, energy-efficient, environmentally friendly device for purifying water for household use.

### FIELD OF THE DISCLOSURE

The present disclosure relates apparatuses and methods for removing contaminants and other impurities from tap water and well water to provide potable water for drinking and cooking.

### BACKGROUND OF THE DISCLOSURE

Tap water from municipal water supplies contains impurities such as iron, lead, microplastics, volatile organic compounds (VOCs), and so-called “forever chemicals” such as per-and polyfluoroalkyl substances (PFAS) and perfluorooctanoate, perfluorooctanoic acid, and perfluorooctane carboxylate (PFOAs). Another impurity in municipal tap water is chlorine, which almost all municipal water works put into the water to guard against microbial contamination. Municipal tap water also contains chloramines, which are compounds based upon chlorine that do not evaporate out and therefore last longer in water. The foregoing list of impurities is not exhaustive. Impurities in tap water are associated with unpleasant taste and odor, and with a variety of health risks. In the United States, it is estimated that 16% of households do not drink their own tap water and 34% of households have some sort of disposable filter used to filter their tap water before drinking it. Therefore, about 50% of all 129 million households do not drink unfiltered municipal tap water because of impurities. In many rural areas, households rely on well water for their water supply. These households typically employ filtration systems, water softeners, and other treatment systems to remove impurities from the well water to make the well water potable.

By far the most common method of filtration is to use activated carbon (activated charcoal) granules in one form or another. The activated carbon granules are good at removing chlorine and tastes and odors, but are not really effective at removing other contaminants like calcium and magnesium which make water hard, nor are they effective at removing microorganisms. Filtration using activated carbon granules has significant drawbacks. Activated carbon granules can be “tuned” to capture certain elements, however this requires that people know what impurities are in their water supply and get an activated carbon filter specifically suited to their water. Activated carbon granules must be thrown away once they become saturated. Consequently, millions of plastic filters containing the granules are thrown into landfills each year. Aside from the environmental impact, the user must check if the filter is plugged or saturated and keep track of when it should be replaced, tasks that are bothersome and subject to procrastination. Households with water having higher levels of impurities need to replace their filters much more often than others.

While activated carbon is effective in removing chlorine and undesirable tastes, it is not truly effective in removing other impurities such as calcium and lead. Water impurities are often expressed as parts per million (PPM) and total dissolved solids (TDS). An inexpensive TDS meter measures the PPM of water by its electrical conductivity. Many common impurities like calcium are charged particles that make water more conductive. By testing the TDS of water before and after activated carbon filtration, it is possible to determine how effectively impurities are being removed. The inventor has found that activated carbon home water filters he tested provide almost no reduction in TDS because activated carbon mostly removes chlorine and tastes, not impurities like lead or calcium which are associated with higher electrical conductivity.

Another method of water filtration is reverse osmosis, or RO. Reverse osmosis uses a fine plastic membrane with very small openings on the order of 0.0001 microns. A pump forces water along the membrane, and only small molecules like water pass through, thus leaving the impurities behind in the pumped water. The problem with RO units is that they waste a lot of water during their process. Also, there is “membrane creep” which happens when the pump stops pumping and water in contact with the membrane leaks its impurities through the membrane, so you have to let the purified water spigot run for a while until impurities that have leaked across the membrane go down the drain. Even worse, if chlorine is not removed from the water before it reaches the membrane, the membrane is quickly ruined. For this reason, it is common to see a bank of filters in every household RO machine for filtering chlorine from the water before the water reaches the membrane. The filters must be changed regularly or the membrane will be ruined. These filters are mostly activated carbon type filters along with some screen filters. So, now the user has to change three or four filters regularly instead of just one filter in an non-RO activated carbon filtration system.

Another water filtration option is a water distiller. The water is boiled away, and the impurities mostly stay behind and coat the electric boiling element, which needs to be cleaned every single boiling operation. In a typical household water distiller, each batch is approximately one gallon, so cleaning must be done frequently. A major problem with distillers is that they pass through VOCs which boil off with the water molecules and condense along with the water. Consequently, an activated carbon filter is attached to remove VOCs. This activated carbon filter needs to be changed regularly too. Another disadvantage of distillers is that they accumulate impurities inside the boiling chamber that must be cleaned using vinegar. In larger distiller units, the residual “gunk” is often scooped out with a spoon or spatula. This process takes several hours to complete. Finally, and importantly, distillers consume a lot of energy. Consequently, distillers are costly to operate to the point that the cost of the purified distilled water approaches the cost of purchasing bottled water at the supermarket.

There are also electrochemical devices that are often called “water softeners.” These devices use ion exchange resin beads to attract and hold positive and negative ions like calcium and iron. These too must be “rejuvenated” by circulating salt water through them regularly, which is a real hassle. The devices do not work at all on VOCs, microorganisms, or any non-charged molecules.

Some water purification devices are designed only to kill microorganisms. Ozone generators generate ozone gas which is bubbled through the water to kill microorganisms. There are also ultraviolet (UV) lamps which kill bacteria. Unlike the water purification devices discussed above, ozone generators and UV lamps operate without replaceable filters that ultimately end up in a landfill. However, ozone generators and UV lamps are ineffective against impurities other than microorganisms.

Water purification devices employing the “freeze-thaw” method of water purification have been described in the patent literature but have failed to succeed commercially. The freeze-thaw method is based on the observation that when water is frozen by flowing raw water over a cold surface, the ice crystals that form reject anything that is not a water molecule, including all different types of impurities, and the moving flow of water carries the rejected impurities away from the formed pure ice.

One patent describing a device employing the freeze-thaw method is U.S. Pat. No. 4,262,489 (Sakamoto). The Sakamoto device has an ice making mechanism 10, a funnel-shaped ice chamber 28 arranged under the ice making mechanism 10, and a water tank 36 arranged under the ice chamber 28. An outlet pipe 44 extends from the water tank 36 and includes a valve 42 for dispensing purified water from the water tank. Because of this vertical arrangement and the need for vertical space to receive cups or other containers of various heights beneath the exit of the outlet pipe 44, the device of Sakamoto is estimated to be more than three-feet tall. As a result, the device of Sakamoto is difficult to accommodate on a household kitchen countertop where overhanging cupboards are commonplace. Sakamoto discloses a heating means 30 located along an outer wall surface of the ice chamber 28 that circulates warm refrigerant from a compressor 32 of the device to melt the collected ice, however the pieces of ice which collect in the ice chamber are not evenly or consistently dispersed relative to the heating means, thereby reducing the efficiency of the heating means in melting the collected ice and introducing significant variation and unpredictability in the time period needed for completion of melting. Moreover, it is necessary to run a refrigerant line 34 near the outer wall surface of ice chamber 28 and provide valves to route the warm refrigerant. The Sakamoto device has a raw water collection tank 50 incorporated into the ice making mechanism 10 located at the very top of the device, thus requiring a separate suspended tank in the device. The teachings of Sakamoto do not translate into a conveniently-sized water purification device suitable for widespread commercial acceptance, especially an inexpensive device suitable for household use.

### SUMMARY OF THE DISCLOSURE

The present disclosure provides an apparatus for purifying water that is suitable for household use, consumes relatively little energy, is low-maintenance, and has no disposable filters or other consumables.

In one embodiment, the apparatus generally comprises a raw water collection tank, a freezing surface, circulation means, refrigeration means, and an ice receptacle. The a raw water collection tank holds raw water having impurities. The circulation means circulates raw water from the raw water collection tank to flow over the freezing surface, and the refrigeration means regulates a temperature of the freezing surface to cause an ice mass to grow by freezing a portion of the raw water as the raw water flows over the freezing surface. An unfrozen portion of the raw water which flows over the freezing surface transports impurities in the ice mass away from the ice mass, and the raw water collection tank is arranged to receive the unfrozen portion of the raw water such that the unfrozen portion of the raw water is recirculated by the circulation means to again flow over the freezing surface. The refrigeration means intermittently raises the temperature of the freezing surface to cause the ice mass to separate from the freezing surface to harvest the ice mass. The ice receptacle is positioned above the raw water collection tank and arranged to receive the ice mass after the ice mass separates from the freezing surface such that the ice mass in the ice receptacle is available for melting to provide purified water. The apparatus may further comprise heating means associated with the ice receptacle for transferring heat to the ice receptacle to melt the ice mass while the ice mass is in the ice receptacle, a purified water outlet conduit in communication with the ice receptacle, and an outlet pump operable to pump purified water from the ice receptacle through the purified water outlet conduit.

In an aspect of the embodiment summarized above, the freezing surface may be configured as an ice cube tray having a plurality of cubic chambers to increase surface area available for freezing, and the refrigeration means may be controlled for a period of time sufficient to cause the individual cubes of the ice mass to fuse together at an outer end into a single slab of ice before the ice mass is harvested and received in the ice receptacle. In contrast to a randomly stacked pile of ice cubes, the single slab of ice received in the ice receptacle has a substantially uniform thickness and will melt in a more uniform and predictable time period when the heating means transfers heat to an underside of the ice receptacle.

In other embodiments, the apparatus may comprise an ice delivery means associated with the ice receptacle for delivering the ice mass through an ice delivery opening in the apparatus housing to an external container where the ice may thaw into purified water. These other embodiments avoid the need for internal space within the housing for storing purified water.

### BRIEF DESCRIPTION OF THE DRAWING VIEWS

The nature and mode of operation of the present invention will now be more fully described in the following detailed description taken with the accompanying drawing figures, in which:

FIG. 1 is schematic illustration of a water purification apparatus formed in accordance with a first embodiment of the present disclosure;

FIG. 2 is schematic illustration of a water purification apparatus formed in accordance with a second embodiment of the present disclosure;

FIG. 3 is schematic illustration of a water purification apparatus formed in accordance with a third embodiment of the present disclosure; and

FIG. 4 is a flow diagram illustrating a water purification cycle in accordance with another embodiment of the present disclosure.

### DETAILED DESCRIPTION OF THE INVENTION

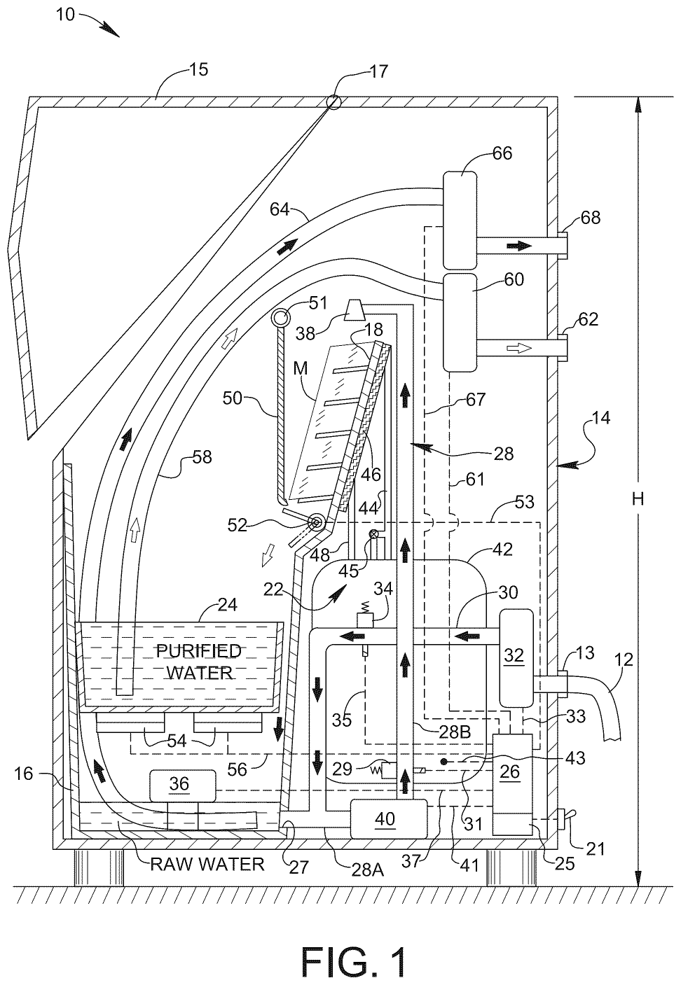

FIG. 1 shows an apparatus 10 for purifying raw water from a raw water source (not shown). The raw water source may be, for example, a municipal water supply or a well. The raw water may be conveyed to a residential home or apartment building, or a commercial structure, through one or more water supply pipes. The raw water may be supplied to apparatus 10 through a water supply hose 12 connected to apparatus 10 at an inlet coupling 13 that conveys raw water from the water supply pipe to apparatus 10. In the figures, flow of raw water is represented by black arrows.

Apparatus 10 may generally comprise a housing 14, a raw water collection tank 16 for holding raw water having impurities, a freezing surface 18, circulation means 20 for flowing raw water from raw water collection tank 16 over freezing surface 18, refrigeration means 22 for regulating a temperature of freezing surface 18, and an ice receptacle 24 positioned above the raw water collection tank 16 and arranged to receive an ice mass M after the ice mass M separates from freezing surface 18. Apparatus 10 may further include a start switch or button 21, an electric power supply 25, and electronic control circuitry 26 arranged and connected to selectively provide power and control signals to electronic components of apparatus 10. As will be described in greater detail below, apparatus 10 operates by flowing raw water over freezing surface 18 in a recirculating manner to cause formation of ice mass M consisting of frozen purified water, and ice mass M is released from freezing surface 18, collected in ice receptacle 24, and melted inside or outside of apparatus 10 to yield purified water. The flow of purified water and movement of purified ice is represented in the figures by white arrows.

Housing 14 may have door 15 which opens to selectively allow access to an interior of housing 14. For example, in the drawings, door 15 is shown as being connected to housing 14 by a hinge 17 to enable door 15 to pivot about a horizontal hinge axis to open and close relative to a fixed countertop portion of housing 14. However, persons skilled in the art will understand that other door arrangements are possible, including sliding doors, doors which completely separate from the fixed countertop portion of housing 14 such as snap-fitted doors, and doors which pivot about a vertical hinge axis relative to the fixed countertop portion of housing 14.

Raw water collection tank 16 may be arranged adjacent to a bottom of housing 14, or may be formed integrally with housing 14 at a base portion of housing 14 such that the bottom of housing 14 also forms a bottom of raw water collection tank 16. Raw water collection tank 16 may be upwardly open and may have a flow portal 27 through which raw water may be conveyed into and out of raw water collection tank 16 via a circulation conduit segment 28A. Flow portal 27 may extend through a sidewall of raw water collection tank 16 proximate the tank bottom as shown in FIG. 1, or at another suitable location. Raw water may be introduced into raw water collection tank 16 by way of water supply hose 12 and a raw water inlet conduit 30 communicating between water supply hose 12 and circulation conduit segment 28A. Water supply hose 12 may be connected to a pressurized water supply line. If inlet pressure is desired or needed, apparatus 10 may have an inlet feed pump 32, such as a diaphragm pump, connected to water supply hose 12 and operable to pump raw water from water supply hose 12 through raw water inlet conduit 30 and circulation conduit segment 28A into raw water collection tank 16. Inlet feed pump 32 is in signal communication with control circuitry 26 along line 33. A flow valve 34, for example a normally closed solenoid valve, may be arranged at a location along raw water inlet conduit 30 for selectively controlling flow through raw water inlet conduit 30. While inlet feed pump 32 is running and/or pressurized water is being introduced into raw water collection tank 16, flow valve 34 is actuated by a signal from control circuitry 26 transmitted along line 35 to an opened state allowing flow through raw water inlet conduit 30. A fill level sensor 36 may be arranged to detect when the level of raw water in raw water collection tank 16 has reached a predetermined fill level corresponding to a fully filled tank. Fill level sensor 36 may be, for example, a float valve or float sensor, an optical sensor, a force (weight) sensor, or other type of sensor capable of generating a signal transmitted along line 37 to control circuitry 26 when the predetermined fill level of raw water collection tank 16 has been reached.

Due to the advantageous positioning of ice receptacle 24 above raw water collection tank 16, the inventor has been able to make a prototype apparatus wherein a height H of housing 14 is about fourteen inches, short enough to fit on a countertop underneath overhead cabinetry.

Circulation means 20 for flowing raw water from raw water collection tank 16 over freezing surface 18 may include a circulation conduit 28 terminating at a delivery nozzle 38 located above freezing surface 18, and a circulation pump 40 installed along circulation conduit 28 to pump raw water from raw water collection tank 16 to delivery nozzle 38. Circulation conduit 28 may include circulation conduit segment 28A upstream from circulation pump 40 and another circulation conduit segment 28B downstream from circulation pump 40. Circulation pump 40 may be controlled by signals from control circuitry 26 transmitted over line 41. A flow valve 29, for example a normally closed solenoid valve, may be arranged at a location along circulation conduit 28 for selectively controlling flow through circulation conduit 28. While circulation pump 40 is running, flow valve 29 is actuated by a signal from control circuitry 26 transmitted along line 31 to an opened state permitting flow through circulation conduit 28.

Freezing surface 18 may be a metal tray similar to those used in ice cube making machines, and may include extended surface portions 19 that increase the surface area for heat transfer. Surface portions 19 may define partitioned chambers having cold surface area on five different faces to expedite freezing. By way of non-limiting example, a metal tray having twenty-four cubic chambers arranged in three rows of eight chambers, each chamber measuring one-inch by one inch by one-inch, provides five square inches of surface area in each chamber multiplied by twenty-four chambers for a total of one-hundred twenty square inches of cold surface area in a volume of measuring eight inches by three inches by one-inch. By contrast, a flat plate having one-hundred twenty square inches of cold surface we would need a cold plate of approximately ten inches by twelve inches, much larger than the eight-inch by three-inch footprint described above.

Freezing surface 18 may be supported above ice receptacle 24 and raw water collection tank 16, for example by connecting freezing surface to an upper wall extension of raw water collection tank 16 or to another structure or interior wall within housing 14. Freezing surface 18 may be inclined at an angle in a range from 10° through 20° relative to vertical to facilitate formation of ice mass M, allow drainage of unfrozen raw water flowing over ice surface 18 and ice mass M into raw water collection tank 16, and cause ice mass M to drop down by force of gravity into ice receptacle 24 when ice mass M releases from freezing surface 18.

In order to regulate the temperature of freezing surface 18, refrigeration means 22 of apparatus 10 may comprise a refrigeration compressor 42 and a hot gas bypass valve 45 controlled by control circuitry 26 over line 43. Refrigeration means 22 is operable to communicate refrigerant through refrigerant pipe 44 to a heat transfer element 46 arranged for heat transfer with freezing surface 18. Refrigerant returns from heat transfer element 46 to refrigeration compressor 42 by way of a return refrigerant pipe 48. Refrigeration compressor 42 may be controlled to regulate the temperature of freezing surface 18 to cause an ice mass M to grow by freezing a portion of the raw water as the raw water flows over the freezing surface. During this process, an unfrozen portion of the raw water flows over freezing surface 18 and transports impurities in ice mass M away from the ice mass. The unfrozen raw water drops down into raw water collection tank 16 and is available for recirculation over freezing surface 18 by circulation means 20. Hot gas bypass valve 45 may be controlled to divert hot gas from compressor 42 to raise the temperature of freezing surface 18 to above the freezing point of water to cause ice mass M to separate from freezing surface 18 and drop down by force of gravity into ice receptacle 24. Separation of ice mass M from freezing surface 18 is sometimes referred to as “harvesting” the ice mass.

In a related aspect, the inventor has found that use of a freezing surface 18 having partitioned chambers is beneficial for transporting impurities away from ice mass M. Impurities that remain in ice mass M and are not flushed away by circulating raw water tend to accumulate on the surfaces of each cube or piece adjacent freezing surface 18 including surface portions 19 (i.e., the bottom and four sides of each cube) where the ice is formed the fastest because there is no coating of ice acting as an insulator to heat transfer. Due to quick freezing of these surface regions, some impurities do not have time to escape and get locked in the surface regions. However, when freezing surface 18 is warmed to thaw and release ice mass M, surface ice nearest freezing surface 18 including extended surface portions 19 melts first, and the impurities located in the surface regions are drained away with the surface melt water from the bottom and sides of each cube before the ice mass fully releases. The only regions that do not get fully flushed during harvesting of ice mass M are the top surfaces of the cubes, for example about twenty-four square inches. By contrast, drawing from the previous example above, in the case of one large ten-inch by twelve inch surface, the entire top surface of one-hundred twenty square inches would not be fully flushed, thereby leaving significantly more impurities in the purified water.

Apparatus 10 may include a spray curtain 50 proximate freezing surface 18 for preventing raw water flowing by the circulation means 20 from entering the ice receptacle ice receptacle 24. Spray curtain 50 may be resiliently deflectable, for example by temporarily pivoting about pivot pin 51, to allow passage of ice mass M from freezing surface 18 to ice receptacle 24. Apparatus 10 may also include an ice release sensor 52 arranged to be activated when ice mass 24 is released from freezing surface 18 and falls into ice receptacle 24. Ice release sensor 52 signals control circuitry 26 along line 53 to indicate the release of ice mass M into ice receptacle 24. As will be understood, ice mass M in ice receptacle 24 is available for melting to provide purified water.

In the embodiment of FIG. 1, a heating means 54 is associated with ice receptacle 24 for transferring heat to the ice receptacle to melt ice mass M once the ice mass is received in the ice receptacle. Heating means 54 may include an electric heater adjacent the underside of ice receptacle 24. Heating means 54 may be controlled by control circuitry 26 connected to the heating means by a line 56. In a beneficial aspect, heating means 54 may include one or more thermoelectric modules (i.e., Peltier modules). Thermoelectric modules are flat solid state heat pumps which pump heat from one side of the module to the other side of the module and may deliver about 2 ½ times the heat energy for ice melting compared to the electrical energy input to the module. By comparison, a resistance heating element would require more than twice the electrical energy input to produce the same heating energy. Advantageously, at the same time the hot side of a thermoelectric module is heating ice receptacle 24, the cold side of the thermoelectric module is refrigerating the interior of housing 14, thereby helping to keep the interior chamber cold. If the opposite sides of a thermoelectric module are near the same temperature, the module may achieve reach a coefficient of performance (COP) above 2.5. In the present application, ice mass M is near the hot side of the module keeping it near 32° F. and the cold side may be at 32° F., so a thermoelectric module offers high efficiency in the present application. As an added advantage, if apparatus 10 is turned off with water still remaining in ice receptacle 24, then upon startup, the water in the ice receptacle 24 will become hot enough to sterilize the water and kill any organisms growing in the water. The use of one or more thermoelectric modules as heating means 54 is a departure from the prior art that eliminates having to route refrigeration lines for thawing the received purified ice, including required valving and pipes, at a very small sacrifice to power consumption. In one embodiment, a small 100 watt to 200 watt 12 volt power supply may be used to power the thermoelectric heaters as heating means 54.

As shown in FIG. 1, apparatus 10 may comprise a purified water outlet conduit 58 in communication with ice receptacle 24 and a purified water outlet pump 60 operable to pump purified water from ice receptacle 24 through the purified water outlet conduit 58 to dispense purified water from apparatus 10. A purified water outlet coupling 62 may be provided on a wall of housing 14 for attachment of a fitting (not shown) through which purified water may be conveyed. Purified water outlet pump 60 may be controlled by signals from control circuitry 26 transmitted over line 61.

As also shown in FIG. 1, apparatus 10 may comprise a raw water outlet conduit 64 in communication with raw water collection tank 16 and a raw water outlet pump 66 operable to pump raw water from raw water collection tank 16 through the raw water outlet conduit 64 to expel raw water from apparatus 10. A raw water outlet coupling 68 may be provided on a wall of housing 14 for attachment of a fitting (not shown) through which raw water may be conveyed. Raw water outlet pump 66 may be controlled by signals from control circuitry 26 transmitted over line 67.

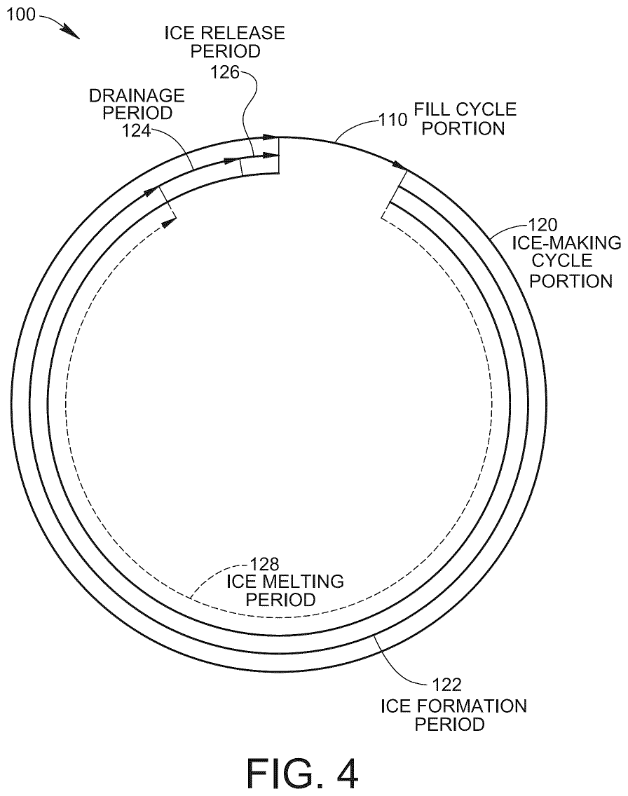

An operating cycle 100 of apparatus 10 will now be described with reference to FIG. 4. As a starting condition, it is assumed that apparatus is connected to an electric power outlet, raw water collection tank 16 is empty, and refrigeration compressor 42 is in a default setting that maintains the interior temperature of housing 14 and the temperature of freezing surface 18 cold enough to enable ice formation when raw water circulated over the freezing surface. When a user activates start switch 19, operating cycle 100 begins in a fill cycle portion 110. During fill cycle portion 110, control circuitry 26 activates inlet feed pump 32 and opens flow valve 34 to introduce raw water from water supply hose 12 into raw water collection tank 16 until control circuitry 26 receives a signal from fill level sensor 36 indicating that raw water collection tank 16 has reached a predetermined fill level and is considered full. During fill cycle portion 110, circulation pump 40 is deactivated and flow valve 29 remains closed such that no raw water is being circulated through circulation conduit 28 to delivery nozzle 38. Raw water outlet pump 66 is also deactivated during fill cycle portion 110. In one embodiment, fill cycle portion lasts approximately thirty seconds.

Upon receipt of the signal from fill level sensor 36, control circuitry 26 terminates the fill cycle portion and transitions to an ice-making cycle portion 120. The fill cycle portion is terminated by deactivating inlet feed pump 32 and closing flow valve 34 to stop the introduction of raw water into raw water collection tank 16 from water supply hose 12.

Ice-making cycle portion 120 may include an ice formation period 122, a drainage period 124, and an ice release period 126. Control circuitry 26 commences ice-making cycle portion 120 by initiating ice formation period 122 during which raw water is recirculated over freezing surface 18 to grow ice mass M. More specifically, control circuitry 26 may start ice formation period 122 by activating circulation pump 40 and opening flow valve 29 such that raw water is pumped from raw water collection tank 16 though circulation conduit 28 until the raw water exits delivery nozzle 38 and drops onto freezing surface 18. During ice formation period 122 of ice-making cycle portion 120, ice mass M gradually grows as more water freezes onto the ice mass. As mentioned above, an unfrozen portion of the raw water which flows over freezing surface 18 transports impurities away from ice mass M such that the ice mass is made up of frozen purified frozen water. The unfrozen raw water drops down into raw water collection tank 16 and is recirculated over freezing surface 18 by circulation means 20.

In an aspect of the present disclosure, control circuitry 26 may be configured or programmed to control a duration of the ice formation period 122 of ice-making cycle portion 120 to allow ice mass M to grow beyond extended surface portions 19 of freezing surface 18 such that individual pieces or cubes of ice mass M formed within individual partitioned chambers of freezing surface 18 become fused together into a single slab of ice having a substantially uniform thickness. As used herein, “ice mass” means one or more pieces of ice, whereas “slab of ice” means one single piece of ice. In order to ensure that ice mass M separates from freezing surface 18 as a slab of ice and not individual pieces or cubes, the duration of ice formation period 122 may be extended beyond the normal duration that a commercial ice making machine would use so that the individual ice cubes fuse together at one end into a unitary slab. This approach guarantees that the entire ice mass M separates from freezing surface 18 at one time and is received by ice receptacle 24 as a single layer of ice having substantially uniform thickness. As a result, it is much easier to melt ice mass M in a fixed short period of time. By contrast, if ice mass M falls into ice receptacle 24 as a pile of discrete separate ice pieces then ice mass M would melt haphazardly depending upon how the pile happens to stack, leading to variation and unpredictability in the time required to completely melt ice mass M. As may be appreciated, the inventor achieves faster freezing time by retaining the increased surface area associated with extended surface portions 19, but overcomes the drawbacks of harvesting ice mass M as several cubes or pieces by extending the duration of the ice formation period 122 of ice-making cycle portion 120. In some embodiments, an ice formation period 122 lasting twelve to fifteen minutes in duration was found to be effective in forming ice mass M into a single ice slab.

With regard to the embodiment illustrated in FIG. 1, it may be seen from FIG. 4 that ice-making cycle portion 120 may also include an ice melting period 128 coinciding with at least the ice formation period 122 during which an ice mass M from a previous iteration of operating cycle 100 is melted by operation of heating means 54. Thus, as a new ice mass M is being formed, the previously formed ice mass M transitions into purified liquid water within ice receptacle 24. As explained above, forming ice mass M as a single slab of substantially uniform thickness provides consistency in the heat needed to melt the ice mass so that the time necessary to melt the ice mass is known and is short enough to occur within the time allocated to ice formation period 122 to form a new ice mass M.

The end of ice-making cycle portion 120 may be signaled by a timer of control circuitry 26. Before ice-making cycle portion 120 ends, control circuitry 26 may commence a drainage period 124 by activating purified water outlet pump 60 and raw water outlet pump 66 for a predetermined period of time sufficient to empty or at least reduce the purified liquid water in ice receptacle 24 and empty the remaining raw water from raw water collection tank 16. Purified water in ice receptacle 24 may be pumped from apparatus 10 to a container (not shown), thereby eliminating the need for additional space within housing 14 for storage of purified water. The raw water in raw water collection tank 16 may be routed to a household drain. In one embodiment, outlet pumps 60 and 66 may be activated for a drainage period 124 lasting about forty-five seconds in duration to remove most of the purified water in ice receptacle 24 and completely empty raw water collection tank 16 of liquid. A portion of purified water may be left in ice receptacle 24 to help thaw the next ice mass M received by the ice receptacle and cushion the fall of the ice mass M into the ice receptacle for quieter operation. The inventor has found it beneficial to retain about an inch deep of water from the previous cycle in ice receptacle 24 (in other words, not completely pumping out the purified water from each ice mass M). The presence of some recently melted water greatly augments uniform melting of each new ice slab due to the warmer water contacting and melting nooks and crannies in the ice slab, where without the water, only portions of the rigid ice slab in direct contact with the bottom of ice receptacle 24 would be directly melted, at least initially until water begins to accumulate in the ice receptacle. One way to ensure leaving a sufficient residual portion of purified water in ice receptacle 24 is to arrange the submerged end of purified water outlet conduit 58 at a vertical distance above the bottom of ice receptacle 24 corresponding to a desired depth of residual water, for example one inch above the bottom of the ice receptacle, so there is always some water that does not get pumped out.

Keeping a portion of residual water in ice receptacle 24 is compatible with expanding the size of ice receptacle 24 to a maximum size allowed by housing 14 and allowing a considerable amount of water to accumulate in ice receptacle 24 before purified water is pumped out. Purified water in ice receptacle 24 is kept cold as long as new ice is falling into the ice receptacle, so one may in principle get rid of an external container for a certain temporary period of time and merely turn on the purified water outlet pump 60 to fill a glass from the accumulated purified water in the ice receptacle 24. For this purpose, a user-operable switch (not shown) for selectively activating purified water outlet pump 60 may be provide on the exterior of housing 14 such that the user would merely have operate the switch (e.g., a push-button switch or the like) on apparatus 10 to fill the glass. While this feature may negatively impact the output capacity of the apparatus 10 and might provide opportunity for microbe growth as purified water in ice receptacle 24 begins to warm up toward room temperature, some users may want a purifier that acts as a “on demand” dispenser of purified water into a glass and may not want to accumulate large amounts of purified water in containers that would be stored in their refrigerator.

Once drainage period 124 has been completed, control circuitry 26 may command hot gas bypass valve 45 of refrigeration means 22 to temporarily increase the regulated temperature of freezing surface 18 above the freezing point of water to cause ice mass M to separate from freezing surface 18 and drop down into ice receptacle 24. This part of ice-making cycle portion 120 is shown as ice release period 126 in FIG. 1. In the embodiment of FIG. 1, the released ice mass M activates ice release sensor 52 as the ice mass drops into ice receptacle 24, which sends a signal to control circuitry 26 that ice-making cycle portion 120 is completed. Operating cycle 100 then repeats itself by control circuitry 26 transitioning to a new fill cycle portion 110. As may be understood, operating cycle 100 may continually repeat itself for extended periods. In one embodiment, apparatus 10 was implemented using an ice-making machine designed to produce forty-five pounds of ice per day, which corresponds to about five and one/half gallons (twenty-one liters) of purified liquid water.

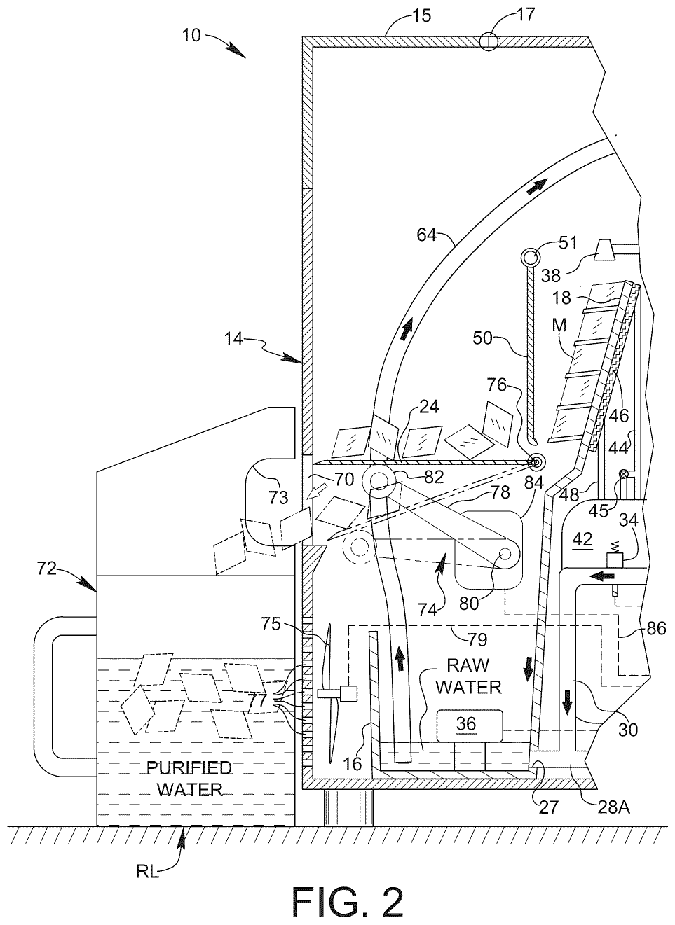

FIG. 2 illustrates an alternative embodiment of apparatus 10 which differs from the embodiment shown in FIG. 1 in several ways. One important difference is that ice mass M is delivered out of housing 14 through an ice delivery opening 70 in housing 14 for thawing in an external container 72. Apparatus 10 of FIG. 2 comprises an ice delivery means 74 associated with ice receptacle 24 for delivering ice mass M through ice delivery opening 70 to an exterior of housing 14, where the ice mass may be directly received into container 72 through an opening 73 in the container. Container 72 may be configured for placement at a receiving location RL externally adjacent to housing 14 to receive ice mass M delivered through ice delivery opening 70. In view of this modification, several subsystem components may be omitted relative to the embodiment of FIG. 1. These include heating means 54 for melting ice mass M while it is in ice receptacle 24, and components for outputting purified water, i.e., purified water outlet conduit 58, purified water outlet pump 60, communication line 61, and purified water outlet coupling 62 may be omitted and ice. Also, ice receptacle 24 may be reconfigured from a container for holding liquid as shown in FIG. 1 to a shallow tray for supporting ice mass M as shown in FIG. 2.

Ice receptacle 24 may be rotatable mounted in housing 14 for rotation about a rotation coupling 76, and ice delivery means 74 may include a motorized support arm 78 which pivots about a pivot joint 80 to selectively tilt ice receptacle 24 about an axis of rotation coupling 76 as illustrated in FIG. 2, whereby ice mass M may slide from inclined ice receptacle 24 through ice delivery opening 70. Support arm 78 may have a roller 82 or other low friction element at its distal end enabling travel relative to an underside of ice receptacle 24. Support arm 78 may be driven to pivot by an electric motor 84, for example a stepper motor, receiving commands from control circuitry 26 over a communication line 85.

It is noted that in the embodiment of FIG. 2, formation of ice mass M into one single slab of ice does not offer the same advantage as in the first embodiment because ice mass M is not melted on a flat surface coupled with a heating means. Thus, the duration of ice-making cycle portion 120 may be adjusted such that ice mass M is released from freezing surface 18 as a plurality of separate pieces or cubes.

In the embodiment of FIG. 2, apparatus 10 may further comprise an exhaust fan 75 for expelling warm air from within housing 14 through vent openings 77 in a direction of container 72 when the container is at receiving location RL to expedite melting of ice mass M in container 72. Exhaust fan 75 may be connected to control circuitry 26 by line 79.

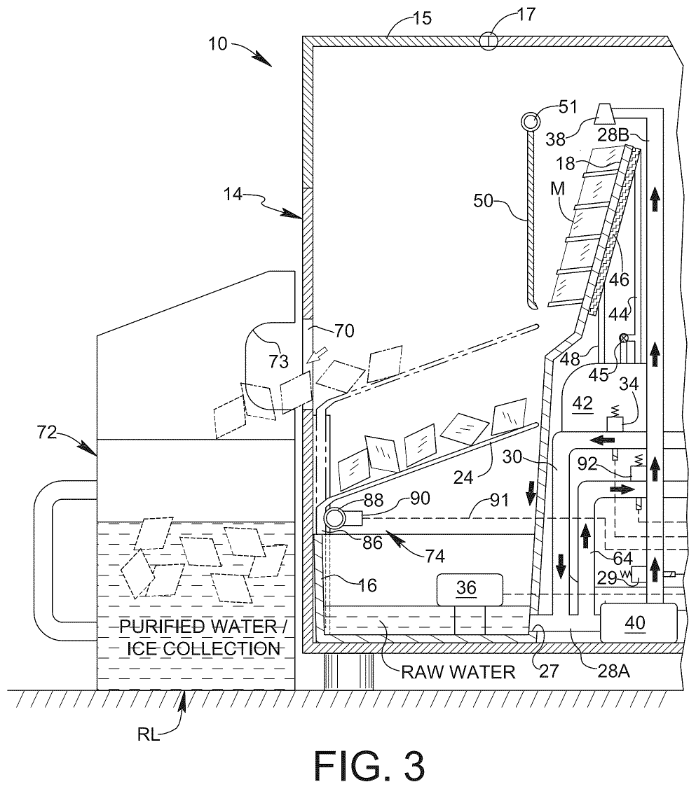

FIG. 3 shows another embodiment of apparatus 10 that is similar to the embodiment of FIG. 2 from the standpoint that ice mass M is melted externally from housing 14 so that purified ice may be accessed in addition to purified water by taking floating purified ice from container 72. The embodiment of FIG. 3 shortens the height of housing 14, a feature that may be advantageous for locating apparatus 10 in spaces where there is a height restriction, for example on a countertop where an overhead cupboard is present. The embodiment of FIG. 3 shows another form of ice delivery means 74. In the embodiment of FIG. 3, ice delivery means 74 may include a traveling rack 86 mounted in housing 14 for reciprocating vertical movement and a pinion gear 88 driven by an electric motor 90, for example a stepper motor, receiving commands from control circuitry 26 over a communication line 91. Rack 86 may be coupled to ice receptacle 24 such that when pinion gear 88 is rotated in one direction, rack 86 and ice receptacle 24 move upward relative to housing 14, and when pinion gear 88 is rotated in an opposite direction, rack 86 and ice receptacle 24 move downward relative to housing 14. Ice receptacle 24 may be arranged at an incline so that when the ice receptacle reaches the height of ice delivery opening 70, ice mass M will slide out of housing 14 through the ice delivery opening.

The embodiment of FIG. 3 illustrates an alternative configuration for removal of raw water from raw water collection tank 16 during drainage period 124. In the alternative configuration, raw water outlet conduit 64 branches from circulation conduit segment 28A and a flow valve 92, for example a normally closed solenoid valve, is arranged at a location along raw water outlet conduit 64 for selectively controlling flow through raw water outlet conduit 64 according to control signals transmitted along line 93. To remove raw water from raw water collection tank 16, control circuitry 26 closes flow valves 29 and 34, opens flow valve 92, and activates raw water outlet pump 66 for a predetermined period of time sufficient to empty the remaining raw water from raw water collection tank 16.

For the embodiments disclosed in FIGS. 2 and 3, operating cycle 100 is modified by eliminating ice melting period 128 because ice mass M is transferred out of housing 14 for melting. Also, because purified water does not need to be pumped from ice receptacle 24, this part of drainage period 124 is eliminated and drainage period 124 is modified to only included drainage of raw water collection tank 16.

The present disclosure and distillation devices of the prior art are both “phase-change” purification devices. As will be understood, freeze-thaw purification according to the present disclosure has several advantages over prior art distillation devices for purifying water. One advantage over distillation is that much lower energy consumption due to the fact that it requires one seventh the energy to freeze water as compared to boiling water. A second advantage is that much less energy is transferred to the air in the room, with much less ambient heating effect. A third advantage over distillation is that zero filtration is required, so there are no filters to replace and discard. A fourth advantage as compared to distillation is that the contaminants are expelled from the apparatus and not stored inside the apparatus, greatly reducing cleaning requirements. A fifth advantage over distillation is that the present disclosure produces ice-cold water that is not conducive to microbial growth, whereas purified water coming off a distiller is quite hot and stays warm for as long as the distiller is functioning, creating perfect conditions for unwanted microbe growth. A sixth advantage of freezing over distillation is that everything in the apparatus stays at a much lower temperature and thus conditions are far less conducive to corrosion of metal components.

While the present disclosure describes exemplary embodiments, the detailed description is not intended to limit the scope of the appended claims to the particular embodiments set forth. The claims are intended to cover such alternatives, modifications and equivalents of the described embodiments as may be included within the scope of the claims.

What is claimed is:

1. An apparatus for purifying raw water from a raw water source, the apparatus comprising:
a raw water collection tank for holding raw water having impurities;
a freezing surface;
circulation means for flowing raw water from the raw water collection tank over the freezing surface;
refrigeration means for regulating a temperature of the freezing surface to cause an ice mass to grow by freezing a portion of the raw water as the raw water flows over the freezing surface, wherein an unfrozen portion of the raw water which flows over the freezing surface transports impurities in the ice mass away from the ice mass, and to cause the ice mass to separate from the freezing surface; and
an ice receptacle positioned above the raw water collection tank and arranged to receive the ice mass after the ice mass separates from the freezing surface;
wherein the raw water collection tank is arranged to receive the unfrozen portion of the raw water such that the unfrozen portion of the raw water is recirculated by the circulation means to again flow over the freezing surface;
wherein the ice mass in the ice receptacle is available for melting to provide purified water.

2. The apparatus according to claim 1, further comprising heating means associated with the ice receptacle for transferring heat to the ice receptacle.

3. The apparatus according to claim 2, wherein the ice receptacle is configured to hold liquid, wherein the heating means is operable to melt the ice mass received by the receptacle to provide purified water held in the ice receptacle.

4. The apparatus according to claim 3, further comprising a purified water outlet conduit in communication with the ice receptacle and an outlet pump operable to pump purified water from the ice receptacle through the purified water outlet conduit.

5. The apparatus according to claim 4, further comprising a user-operable switch for selectively activating the purified water outlet pump.

6. The apparatus according to claim 4, wherein an end of the purified water outlet conduit is located in the ice receptacle at a predetermined vertical distance from a bottom of the ice receptacle.

7. The apparatus according to claim 1, further comprising a raw water inlet conduit in communication with the raw water collection tank for conveying raw water into the raw water collection tank.

8. The apparatus according to claim 7, further comprising an inlet feed pump operable to pump raw water through the raw water inlet conduit and into the raw water collection tank.

9. The apparatus according to claim 1, further comprising a raw water outlet conduit in communication with the raw water collection tank and a raw water outlet pump operable to pump raw water from the raw water collection tank through the raw water outlet conduit.

10. The apparatus according to claim 8, further comprising an ice release sensor configured and arranged to sense separation of the ice mass from the freezing surface and electronic control circuitry connected to the ice release sensor, wherein the electronic control circuitry is configured to turn on the inlet feed pump in response to a separation signal from the ice sensor.

11. The apparatus according to claim 10, wherein the electronic control circuitry is configured to turn off the inlet feed pump and turn on the circulation means after a predetermined time period has elapsed.

12. The apparatus according to claim 2, wherein the ice mass received in the ice receptacle consists of a single slab of ice having a substantially uniform thickness, and wherein the heating means transfers heat to an underside of the ice receptacle.

13. The apparatus according to claim 12, wherein the freezing surface defines a plurality of cubic freezing chambers, each of the plurality of cubic freezing chambers having five faces defined by the freezing surface and one open face.

14. The apparatus according to claim 1, wherein the freezing surface is inclined at an angle in a range from 10° through 20° relative to vertical.

15. The apparatus according to claim 1, further comprising a spray curtain proximate the freezing surface for preventing raw water flowing by the circulation means from entering the ice receptacle.

16. The apparatus according to claim 15, wherein the spray curtain is resiliently deflectable to allow passage of the ice mass from the freezing surface to the ice receptacle.

17. The apparatus according to claim 1, further comprising a housing containing the raw water collection tank, the freezing surface, and the ice receptacle, wherein the housing includes an ice delivery opening and the apparatus further comprises ice delivery means for delivering the ice mass through the ice delivery opening to an exterior of the housing.

18. The apparatus according to claim 17, further comprising a container, wherein the container is configured for placement at a receiving location externally adjacent to the housing to receive the ice mass delivered through the ice delivery opening.

19. The apparatus according to claim 18, further comprising an exhaust fan for expelling warm air from the housing in a direction of the container when the container is at the receiving location.

20. An apparatus for purifying raw water from a raw water source, the apparatus comprising:
a raw water collection tank for holding raw water having impurities;
a freezing surface;
circulation means for flowing raw water from the raw water collection tank over the freezing surface;
refrigeration means for regulating a temperature of the freezing surface to cause an ice mass to grow by freezing a portion of the raw water as the raw water flows over the freezing surface, wherein an unfrozen portion of the raw water which flows over the freezing surface transports impurities in the ice mass away from the ice mass, and to cause the ice mass to separate from the freezing surface;
an ice receptacle arranged to receive the ice mass after the ice mass separates from the freezing surface; and
heating means associated with the ice receptacle for transferring heat to the ice receptacle;
wherein the ice mass received in the ice receptacle consists of a single slab of ice having a predefined substantially uniform thickness, and wherein the heating means transfers heat to an underside of the ice receptacle;
wherein the raw water collection tank is arranged to receive the unfrozen portion of the raw water such that the unfrozen portion of the raw water is recirculated by the circulation means to again flow over the freezing surface;
wherein the ice mass in the ice receptacle is available for melting to provide purified water.

21. The apparatus according to claim 20, wherein the freezing surface defines a plurality of cubic freezing chambers, each of the plurality of cubic freezing chambers having five faces defined by the freezing surface and one open face.

22. An apparatus for purifying raw water from a raw water source, the apparatus comprising:
a housing;
a raw water collection tank within the housing for holding raw water having impurities;
a freezing surface within the housing;
circulation means for flowing raw water from the raw water collection tank over the freezing surface;
refrigeration means for regulating a temperature of the freezing surface to cause an ice mass to grow by freezing a portion of the raw water as the raw water flows over the freezing surface, wherein an unfrozen portion of the raw water which flows over the freezing surface transports impurities in the ice mass away from the ice mass, and to cause the ice mass to separate from the freezing surface;
an ice receptacle arranged to receive the ice mass after the ice mass separates from the freezing surface, wherein the ice receptacle is configured to hold liquid; and
heating means associated with the ice receptacle for transferring heat to the ice receptacle, wherein the heating means is operable to melt the ice mass received by the receptacle to provide purified water held in the ice receptacle;
a purified water outlet conduit in communication with the ice receptacle;
a purified water outlet pump operable to pump purified water from the ice receptacle through the purified water outlet conduit;
an ice release sensor configured and arranged to sense separation of the ice mass from the freezing surface; and
electronic control circuitry for controlling operation of the circulation means, the heating means, and the outlet pump in an operating cycle including an ice formation period and a drainage period;
wherein during the ice formation period the circulation means is operated to grow the ice mass on the freezing surface and the heating means is operated to melt ice in the ice receptacle;
wherein during the drainage period the purified water outlet pump is operated to pump at least a portion of purified water in the ice receptacle through the purified water outlet conduit;
wherein the raw water collection tank is arranged to receive the unfrozen portion of the raw water such that the unfrozen portion of the raw water is recirculated by the circulation means to again flow over the freezing surface.

23. The apparatus according to claim 22, further comprising a user-operable switch for selectively activating the purified water outlet pump.

24. An apparatus for purifying raw water from a raw water source, the apparatus comprising:
a housing including a bottom wall and one or more sidewalls extending vertically relative to the bottom wall, where the one or more sidewalls includes an ice delivery opening;
a raw water collection tank within the housing for holding raw water having impurities;
a freezing surface within the housing;
circulation means for flowing raw water from the raw water collection tank over the freezing surface;
refrigeration means for regulating a temperature of the freezing surface to cause an ice mass to grow by freezing a portion of the raw water as the raw water flows over the freezing surface, wherein an unfrozen portion of the raw water which flows over the freezing surface transports impurities in the ice mass away from the ice mass, and to cause the ice mass to separate from the freezing surface; and
ice delivery means for delivering the ice mass through the ice delivery opening to an exterior of the housing after the ice mass separates from the freezing surface, wherein the delivered ice mass is available for melting to provide purified water;
wherein the raw water collection tank is arranged to receive the unfrozen portion of the raw water such that the unfrozen portion of the raw water is recirculated by the circulation means to again flow over the freezing surface.
